(19) United States
(12) Patent Application Publication
(10) Pub. No.: US 2011/0083421 A1
(43) Pub. Date: Apr. 14, 2011

(54) EXHAUST GAS TREATMENT DEVICE AND CORRESPONDING MANUFACTURING PROCESS

(76) Inventor: Thomas NORDING, Esslingen (DE)

(21) Appl. No.: 12/752,484

(22) Filed: Apr. 1, 2010

(30) Foreign Application Priority Data
Apr. 2, 2009 (DE) 10 2009 015 625.9

(51) Int. Cl. F01N 3/08; B23P 17/00

(52) U.S. Cl. 60/272; 29/890.08

(57) ABSTRACT

An exhaust gas treatment device (1) for an exhaust system of an internal combustion engine has a housing (2), which has a jacket (4) and at least one bottom (7) on the end side. A simplified variant arises if at least one such bottom (7) is designed as a spherical or spherical segment-shaped hood. The hood (8) has a connection opening (9), and a connecting branch (10, 11) is attached to the hood (8) in the area of the connection opening (9).

### CROSS REFERENCE TO RELATED APPLICATIONS

This application claims the benefit of priority under 35 U.S.C. §119 of German Patent Application DE 10 2009 015 625.9 filed Apr. 2, 2009, the entire contents of which are incorporated herein by reference.

### FIELD OF THE INVENTION

The present invention pertains to a process for manufacturing an exhaust gas treatment device for an exhaust system of an internal combustion engine. Moreover, the present invention pertains to an exhaust gas treatment device for an exhaust system of an internal combustion engine. Furthermore, the present invention also pertains to a kit for manufacturing an exhaust gas treatment device.

### BACKGROUND OF THE INVENTION

An exhaust gas treatment device, such as, e.g., a particle filter, a catalytic converter, an exhaust muffler or any combinations thereof, used in motor vehicles, usually has a housing, which has a jacket on the peripheral side and a bottom on each end side. Furthermore, it is usual to design at least one connection, namely an exhaust gas inlet or an exhaust gas outlet, on at least one of these end-side bottoms.

For different installation situations, which may vary greatly in case of different vehicle models or embodiments, it is necessary to be able to mount the respective exhaust gas treatment device with different spatial positions. For example, different angles between a longitudinal central axis of the housing and supplying or discharging gas lines have to be created for this.

For this, it is possible, e.g., to design the respective bottom as a funnel, which is made integral with a corresponding connecting branch, whereby a longitudinal central axis of the respective connecting branch can correspondingly be sloped opposite the longitudinal central axis of the housing. To now be able to create a plurality of different supply angles or discharge angles, a corresponding number of funnels with matching configurations has to be provided. This is connected with a considerable expense for tools and storage as well as logistics.

### SUMMARY OF THE INVENTION

The present invention pertains to the object of providing an exhaust gas treatment device of the type mentioned in the introduction that especially makes possible a simplified manufacture and thus a low-cost production.

According to one aspect of the invention, a process is provided for manufacturing an exhaust gas treatment device for an exhaust system of an internal combustion engine. The process comprises providing the exhaust gas treatment device with a housing having a jacket on a peripheral side and at least one bottom on an end side and manufacturing at least one such bottom as a spherical or spherical segment-shaped hood. A connection opening is provided in the hood. The process further includes attaching a connecting branch to the hood in the area of the connection opening.

According to another aspect of the invention, an exhaust gas treatment device is provided for an exhaust system of an internal combustion engine. The exhaust gas treatment device comprises a housing with a jacket and at least one bottom on an end side. The at least one bottom comprises a spherical or spherical segment-shaped hood. The hood has a connection opening. A connecting branch is attached to the hood in the area of the connection opening.

The present invention is based on the general idea of designing at least one of the end-side bottoms of the housing as a hood, which has a spherical shape or a spherical segment shape. This especially is a hemispherical hood provided with a connection opening, e.g., by means of a corresponding tool in more or less any spatial position. A standardized connecting branch may then be attached to this connection opening in an especially simple manner and be connected to the hood. In this way, more or less any spatial alignment of the connecting branch with regard to the longitudinal central axis of the housing, which axis is designed individually for the respective installation situation, may be achieved by means of only two standard components, namely the hood and the connecting branch. Thus, the suggested mode of construction makes it possible to be able to adapt exhaust gas treatment device cost-effectively to highly varying installation situations.

On its connecting end facing the hood, the respective connecting branch may preferably be shaped in a complementary manner to the outer contour of the hood. Consequently, a flat contact can be produced between connecting branch and hood. For example, on its connecting end, the connecting branch is equipped with an annular, circumferential, spherical-segment-shaped collar, which has a shape matching the spherical or spherical segment shape of the hood. Such a shaping simplifies the assembly and at the same time makes possible a simple tolerance compensation.

The connecting end of the connecting branch facing the hood may lie in a plane, which runs at right angles to the longitudinal central axis of the connecting branch. Likewise, an embodiment is possible, in which the connecting end of the connecting branch lies in a plane, which runs sloped, e.g., by about 45°, opposite a normal plane running at right angles to the longitudinal central axis of the connecting branch. By means of such oblique or sloped connecting branches, it is especially possible to create an angle of 90° between the longitudinal central axis of the connecting branch and the longitudinal central axis of the housing.

A collar is made integral with the hood, by means of which the hood can be detachably fastened to the jacket via a clamp connection.

At least one jacket type, by means of which the respective jacket of the respective housing can be manufactured, at least one hood type without connection opening and matching the respective type of jacket, as well as one connecting branch type matching the respective hood are found within a kit according to the present invention, by means of which the exhaust gas treatment device according to the present invention can be manufactured or by means of which the process according to the present invention for manufacturing the exhaust gas treatment device can be carried out. It is clear that jacket types, hood types and connecting branch types of different sizes may also be provided for exhaust gas treatment device of different sizes.

Further important features and advantages of the present invention appear from the subclaims, from the drawings and from the corresponding description of the figures on the basis of the drawings.

It is obvious that the above-mentioned features, which will also be explained below, can be used not only in the particular combination indicated, but also in other combinations or alone without going beyond the scope of present invention.

Preferred exemplary embodiments of the present invention are shown in the drawings and will be explained in more detail in the following description, where identical reference numbers designate identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a highly simplified longitudinal cross sectional view through an exhaust gas treatment device in the area of a bottom, showing one embodiment;

FIG. 2 is a highly simplified longitudinal cross sectional view through an exhaust gas treatment device in the area of a bottom, showing another embodiment;

FIG. 3a is a longitudinal cross sectional view through a hood showing one of various variants;

FIG. 3b is a longitudinal cross sectional view through a hood showing another of various variants;

FIG. 3c is a longitudinal cross sectional view through a hood showing another of various variants;

FIG. 4a is a view of a connecting branch;

FIG. 4b is a view of another connecting branch;

FIG. 4c is a view of a housing in a stage of a manufacturing process;

FIG. 5a is a view of a connecting branch;

FIG. 5b is a view of another connecting branch;

FIG. 5c is a view of a housing in a further stage of a manufacturing process as compared to FIG. 4c;

FIG. 6a is a view of a connecting branch;

FIG. 6b is a view of another connecting branch connected to a hood; and

FIG. 6c is a view of a housing in a stage of a manufacturing process showing the connecting branch connected to the hood;

### DESCRIPTION OF THE PREFERRED EMBODIMENTS

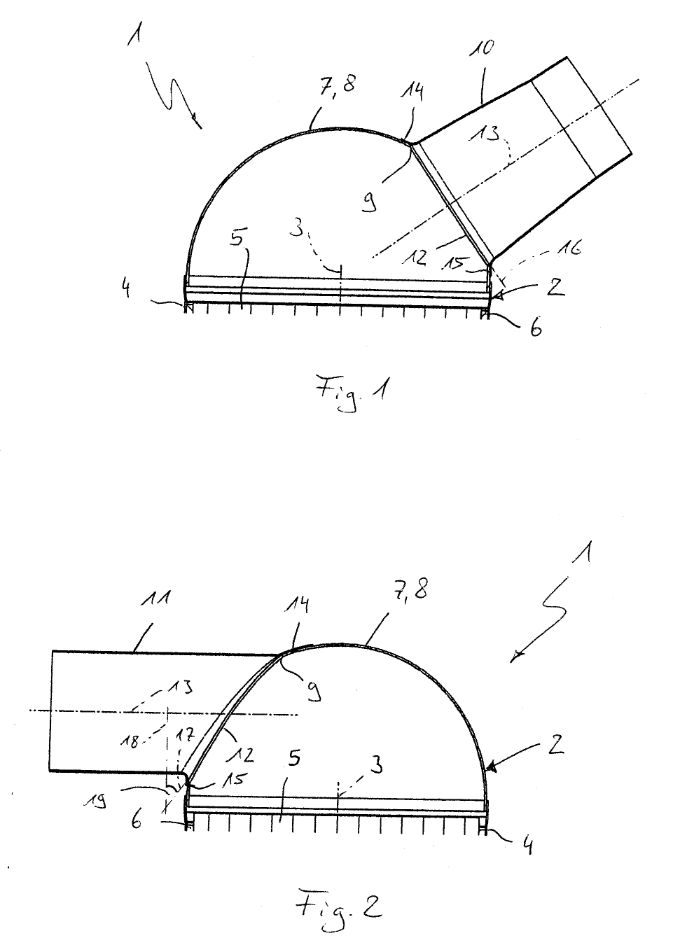

Referring to the drawings in particular, according to FIGS. 1 and 2, an only partly shown exhaust gas treatment device 1 which is suitable for use in an exhaust system of an internal combustion engine has a housing 2. This housing 2 has, with regard to a longitudinal central axis 3 of the housing 2, a circumferential jacket 4 closed on the peripheral side. The jacket 4 encloses or envelops at least one exhaust gas treatment element 5, and a mounting mat 6 may usually be arranged between the jacket 4 and exhaust gas treatment element 5. Furthermore, the housing 2 has on the end side, i.e., with regard to its longitudinal central axis 3, axially two end bottoms 7, only one of which can be seen in both FIGS. 1 and 2.

The internal combustion engine, e.g., a diesel engine or spark ignition engine, can likewise be used in vehicles, in road vehicles, in construction vehicles, in so-called non-road vehicles, as well as in watercraft, i.e., in boats, as in stationary means, such as, e.g., block-type thermal power stations or constructions machines or generators.

The exhaust gas treatment device 1 may be designed, e.g., as a particle filter means. The exhaust gas treatment element 5 is correspondingly then a particle filter element. As an alternative, the exhaust gas treatment device 1 may also be a catalytic converter means, so that the exhaust gas treatment element 5 is then a catalytic converter element. Combined means, in which, e.g., an oxidation catalytic converter element is arranged upstream of a particle filter element, are likewise conceivable.

At least one of the bottoms 7, the bottom 7 shown here, is designed as a hood 8 that has a spherical or spherical segment shape. In the examples shown, the hood 8 has a hemispherical shape. The hemispherical hood 8 is attached to the jacket 4 in the area of its “equator.” Furthermore, the hood has a connection opening 9, which passes through hood 8 and which can be used as an inlet opening or as an outlet opening for exhaust gas in the finished state of the exhaust gas treatment device 1. Moreover, a connecting branch 10 (FIG. 1) or 11 (FIG. 2) is attached to hood 8. The connecting branch 10, 11 is thereby attached to the hood 8 in the area of the respective connection opening 9, so that said connecting branch 10, 11 communicates with the interior of the hood 8 by means of the respective connection opening 9. As a result, the respective connecting branch 10, 11 forms an inlet pipe connection or an outlet pipe connection for exhaust gas in the finished state of the exhaust gas treatment device 1. The respective connecting branch 10, 11 is preferably welded to the hood 8. For this, the respective connecting branch 10, 11 can, on a connecting end 12 facing the hood 8, be equipped with a circumferential collar 14, projecting outwardly and closed in the circumferential direction with regard to a longitudinal central axis 13 of the respective connecting branch 10, 11. Said collar 14 is preferably shaped in a complementary manner to the outer contour of the hood 8 in the area of an opening edge 15 enclosing the respective connection opening 9. Consequently, a flat contact is produced between collar 14 and opening edge 15, which simplifies the manufacture of a gas-tight connection between connecting branch 10, 11 and hood 8.

The respective connecting branch 10, 11 may have a linear configuration. Correspondingly, it has a linear longitudinal central axis 13.

In the embodiment shown in FIG. 1, connecting branch 10 has a truncated-cone-shaped section, which converges slightly with increasing distance from hood 8. Furthermore, in this embodiment, the connecting end 12 of the connecting branch 10 is designed such that it lies in a plane 16, which extends at right angles to the longitudinal central axis 13 of the connecting branch 10.

In contrast, FIG. 2 shows an embodiment, in which the connecting branch 11 has a cylindrical shape and correspondingly has a constant cross section over its entire length. Furthermore, in this embodiment, the connecting end 12 of the connecting branch 11 lies in a plane 17, which encloses an angle 19 with a normal plane 18, i.e., is sloped opposite the normal plane 18. Said normal plane 18 extends at right angles to the longitudinal central axis 13 of the connecting branch 11. Thus, the connecting branch 11 shown in FIG. 2 is sloped on the connection side. Consequently, other angular areas may be created between the two longitudinal central axes 3, 13 of the respective connecting branch 10, 11 and of the housing 2 or the jacket 4. For example, the sloped connecting branch 11 makes possible an angle of about 90° between the longitudinal central axis 3 of the housing 2 and the longitudinal central axis 13 of the connecting branch 11.

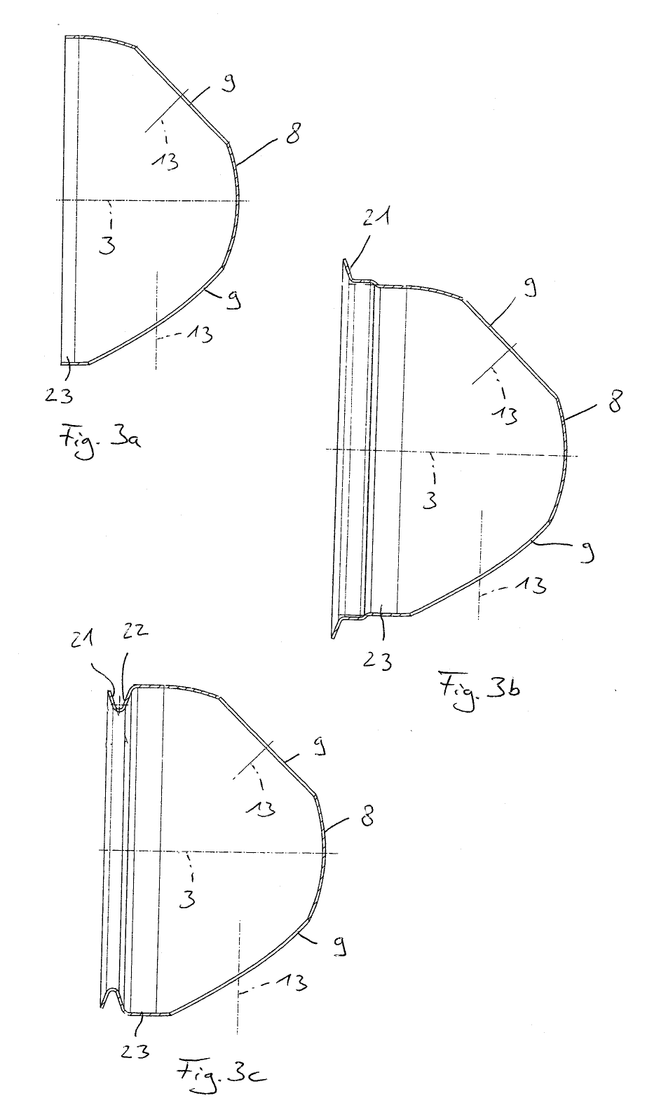

FIGS. 3a, 3b and 3c show three embodiments of the hood 8 in a complementary manner. The hood 8 shown in FIG. 3a corresponds to those of FIGS. 1 and 2. In FIGS. 3b through 3c, the hood 8 is designed such that it can be detachably fastened to the respective jacket 4 by means of a clamp (not shown). For this, the hood 8 is provided, on a side facing the jacket 4, with a circumferential collar 21 with regard to the longitudinal central axis 3 of housing 2. This may optionally be made integral with the hood 8. In the example of FIG. 3c, moreover, a circumferential annular groove 22 is shaped at the transition to the collar 21. The respective clamp may mesh with this annular groove 22 in order to cooperate with the collar 21. It is clear that other configurations, especially with attached collar, are also conceivable. Furthermore, it is clear that the respective hood 8 has usually only one connection opening 9 and not two as shown in FIGS. 3a through 3c. Moreover, it can be taken from FIGS. 3a through 3c that the hood 8 may have, on the side facing the jacket 4, a cylindrical section 23, which simplifies the connection to the cylindrical jacket 4.

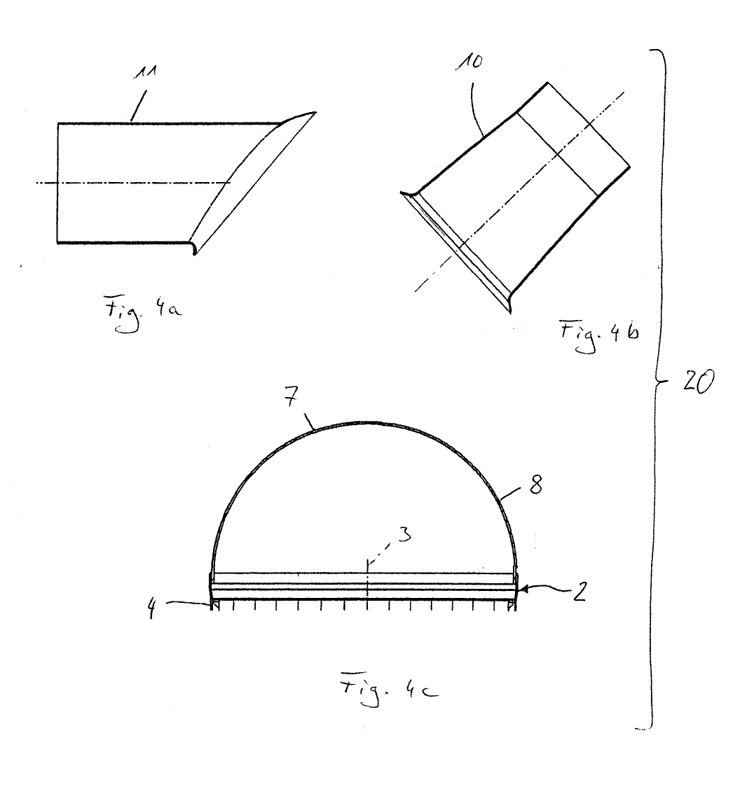

A kit according to the present invention is designated globally as 20 in FIGS. 4a, 4b and 4c. The exhaust gas treatment device 1 can be manufactured by means of this kit 20. According to FIGS. 4a through 4c, it contains at least one jacket type for manufacturing the jacket 4 of the housing, as well as at least one hood type, matching the respective jacket type, for manufacturing the hood 8 matching the jacket 4. Furthermore, the kit 20 contains at least one connecting branch type. In the overall view of FIGS. 4a, 4b and 4c, the two different connecting branches 10, 11 of FIGS. 1 and 2 are shown purely by way of example. The connecting branch 11 of FIG. 4a corresponds to the connecting branch 11 of FIG. 2, while the connecting branch 10 of FIG. 4b corresponds to the connecting branch 10 of FIG. 1. Within the kit 20, the respective hood 8 is provided without the connection opening 9. It is clear that the kit 20 may also have different jacket types for manufacturing jackets 4 of different sizes, as well as hood types matching them. Connecting branch types of different sizes may also be present.

A process for manufacturing the exhaust gas treatment device 1 is explained in detail below on the basis of FIGS. 4a through 6c.

At first, according to FIGS. 4a, 4b and 4c, the spherical or spherical segment-shaped or hemispherical hood 8 is manufactured or provided in the kit 20. The hood 8 can be used universally for any angle between the longitudinal central axis 3 of the housing 2 and the longitudinal central axis 13 of the still-to-be-mounted connecting branch 10, 11. The hood 8 may be manufactured, e.g., from a flat sheet metal by means of deep drawing or by means of pressing.

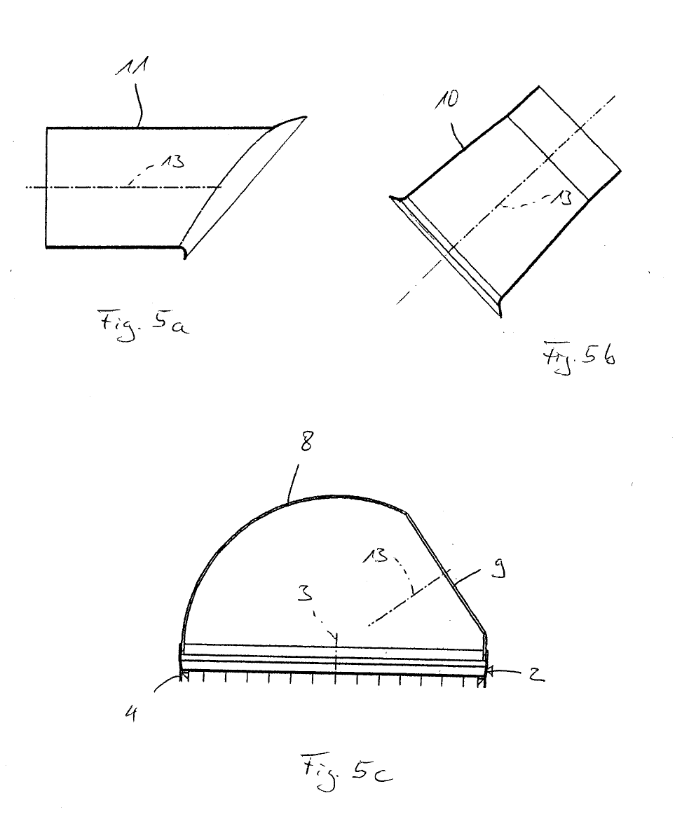

As soon as the angle to be created between the longitudinal central axis 3 of the housing 2 and the longitudinal central axis 13 of the respective connecting branch 10, 11 is established, the connection opening 9 is made on a point of the hood 8 suitable for this, the state of which is shown in FIGS. 5a, 5b and 5c. The connection opening 9 may be made, e.g., by means of a suitable cutting tool or by means of a punching tool or by means of a laser welding process. Due to the positioning of the connection opening 9, the longitudinal central axis 13 of the later connecting branch 10, 11 is already more or less fixed, at least when it is the linear connecting branch 10 according to FIG. 5b.

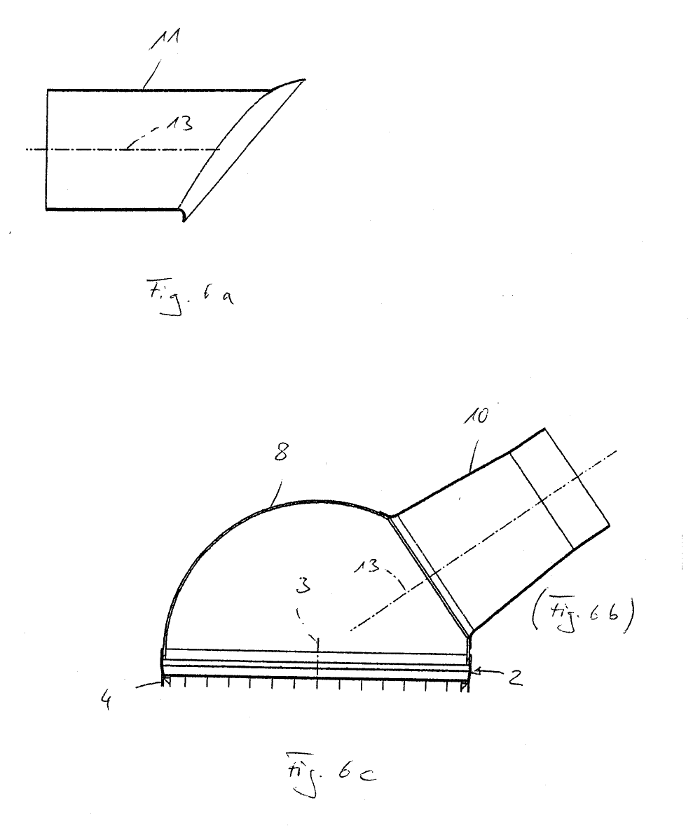

The matching connecting branch, here the linear connecting branch 10 corresponding to FIGS. 6a, 6b and 6c, can then be mounted. For this, the respective connecting branch 10 is attached to the hood 8 in the area of the connection opening 9. As mentioned, the connecting branch 10 can, e.g., be welded or soldered to the hood 8. The state shown in FIG. 6c corresponds here to the view according to FIG. 1.

In the example shown the hood 8 is already in a state, in which it still does not have a connection opening 9, attached to the jacket 4. It is clear that the hood 8 may also be attached to the jacket 4 at a later point in time, especially after the manufacture of the connection opening 9 and/or after the attachment of the respective connecting branch 10, 11.

In the connection of hood 8 and jacket 4, the usual manufacturing methods may be considered, and especially also a downsizing or compression of the jacket 4 within the framework of the canning process, in which the respective exhaust gas treatment insert 5 is inserted into the jacket 4 and in which the respective jacket 4 is adapted to the dimensions of the respective exhaust gas treatment insert 5.

It is clear that the individual features of the different embodiments shown here may be combined with one another in any way as well in order to achieve mixed or new embodiments.

While specific embodiments of the invention have been described in detail to illustrate the application of the principles of the invention, it will be understood that the invention may be embodied otherwise without departing from such principles.

What is claimed is:

1. A process for manufacturing an exhaust gas treatment device for an exhaust system of an internal combustion engine, the process comprising:
providing the exhaust gas treatment device with a housing having a jacket on a peripheral side and at least one bottom on an end side;
manufacturing at least one such bottom as a spherical or spherical segment-shaped hood;
providing a connection opening in the hood; and
attaching a connecting branch to the hood in the area of the connection opening.

2. A process in accordance with claim 1, wherein the connecting branch is attached by welding the connecting branch to the hood.

3. A process in accordance with claim 1, wherein the connecting branch has a linear configuration.

4. A process in accordance with claim 1, wherein the connecting branch has a connecting end facing the hood, the connecting branch connecting end being shaped in a complementary manner to the outer contour of the hood.

5. A process in accordance with claim 1, wherein the connecting branch has a connecting end facing the hood, the connecting branch connecting end lying in a plane that is sloped opposite a normal plane, the normal plane being at right angles to the longitudinal central axis of the connecting branch.

6. An exhaust gas treatment device for an exhaust system of an internal combustion engine, the exhaust gas treatment device comprising:
a housing with a jacket and at least one bottom on an end side, the at least one bottom comprising a spherical or spherical segment-shaped hood, the hood having a connection opening; and
a connecting branch attached to the hood in the area of the connection opening.

7. An exhaust gas treatment device in accordance with claim 6, wherein the connecting branch is welded to the hood.

8. An exhaust gas treatment device in accordance with claim 6, wherein the connecting branch has a linear configuration.

9. An exhaust gas treatment device in accordance with claim 6, the connecting branch has a connecting end facing the hood, the connecting branch connecting end being shaped in a complementary manner to an outer contour of the hood.

10. An exhaust gas treatment device in accordance with claim 6, wherein the connecting branch has a connecting end facing the hood, the connecting branch connecting end lying in a plane that is sloped opposite a normal plane, the normal plane being at right angles to a longitudinal central axis of the connecting branch.

11. An exhaust gas treatment device in accordance with claim 6, further comprising a clamp, wherein the hood is detachably fastened to the jacket by means of the clamp.

12. An exhaust gas treatment device in accordance with claim 11, further comprising a circumferential collar cooperating with the clamp, the circumferential collar being made integral with the hood.

13. A kit for manufacturing an exhaust gas treatment device comprising a housing with a jacket and at least one bottom on an end side, the at least one bottom comprising a spherical or spherical segment-shaped hood, the hood having a connection opening and a connecting branch attached to the hood in the area of the connection opening, the kit comprising:
at least one jacket type for manufacturing the jacket of the housing;
at least one hood type for manufacturing the respective bottom of the housing; and
at least one connecting branch type for attaching the respective connecting branch to the hood provided with the connection opening.

14. A kit in accordance with claim 13, wherein the connecting branch has a linear configuration.

15. A kit in accordance with claim 13, wherein the connecting branch has a connecting end facing the hood, the connecting branch connecting end being shaped in a complementary manner to the outer contour of the hood.

16. A kit in accordance with claim 13, wherein the connecting branch has a connecting end facing the hood, the connecting branch connecting end lying in a plane that is sloped opposite a normal plane, the normal plane being at right angles to the longitudinal central axis of the connecting branch.

17. A kit in accordance with claim 13, further comprising a clamp, wherein the hood may be detachably fastened to the jacket by means of the clamp.

18. An kit in accordance with claim 13, further comprising a circumferential collar cooperating with the clamp, the circumferential collar being made integral with the hood.
